(19) United States
(12) Patent Application Publication
(10) Pub. No.: US 2013/0235227 A1
(43) Pub. Date: Sep. 12, 2013

(54) IMAGE CAPTURING DEVICE AND METHOD THEREOF AND HUMAN RECOGNITION PHOTOGRAPH SYSTEM

(71) Applicants: Wen-Yan CHANG, Miaoli County (TW); Tai-Chang YANG, Kaohsiung City (TW); Hong-Long CHOU, Taipei City (TW)

(72) Inventors: Wen-Yan CHANG, Miaoli County (TW); Tai-Chang YANG, Kaohsiung City (TW); Hong-Long CHOU, Taipei City (TW)

(21) Appl. No.: 13/461,328

(22) Filed: May 1, 2012

(30) Foreign Application Priority Data
Mar. 7, 2012 (TW) 101107642

(51) Int. Cl. H04N 5/228

(52) U.S. Cl. 348/222.1; 348/E05.031

(57) ABSTRACT

This invention discloses an image capturing device, an image capturing method, and a human recognition photograph system. The image capturing device comprises: a capturing module sensing an image; a human detecting module detecting the number of at least one person in an image generating detecting signal; a face recognition module generates recognition signal by recognizing a face condition of the at least one person in the image; and a processing module that receives detecting signal and recognition signal and calculates the number of at least one person and face condition value according to the detecting signal and the recognition signal respectively. The processing module determines whether the number of at least one person and face condition value correspond to a predetermined number and a predetermined face condition value respectively; if so, generating an image capturing signal to control the capturing module to capture image and generate image data.

### CROSS-REFERENCE TO RELATED APPLICATION

This application claims the benefit of Taiwan Patent Application No. 101107642, filed on Mar. 7, 2012, in the Taiwan Intellectual Property Office, the disclosure of which is incorporated herein in its entirety by reference.

### BACKGROUND OF THE INVENTION

1. Field of the Invention

The present invention relates to an image capturing device, an image capturing method, and a human recognition photography system, and more particularly to the image capturing device, the image capturing method and the human recognition photography system that combine a human detecting module and a face recognition module to detect a number of at least one person or a face condition to capture the best image.

2. Description of Related Art

As science and technology advance and people pay more attention on recreation in recent years, during a holiday trip, most people would like to take photos with their camera regardless of scenic photos and portraits by camera. Therefore, the cameras available in the market having the automatic shooting function facilitates automatic photographic for the user by setting the photographing time, so that the users may complete the automatic photographing process independently.

Present existing cameras generally come with the automatic photographing function which is implemented by a time countdown method to control the photographing time and take photos automatically, since a photographic procedure can be completed as soon as the time countdown ends. However, when the camera is used outdoors including a scenic area, pedestrians or other tourists are walking around, and these pedestrians or tourists may be easily included in the photo taken by the time countdown method and ruin the overall aesthetics of the photo. Therefore, the photos taken by the conventional cameras with the automatic photographic function may have flaws easily due to the difficulty in controlling the timing of the photo being taken, and fails to provide users with a way to take perfect photos.

Therefore, the present invention can improve the drawbacks of the conventional cameras with the automatic photographic function, to improve the timing of the automatic photographic function to take photos at the best time and overcome the problem of easily having flaws in the photos taken.

### SUMMARY OF THE INVENTION

In view of the aforementioned problems of the prior art, it is a primary objective of the invention to provide an image capturing device, an image capturing method and a human recognition photography system to overcome the problems of the users having a difficulty in controlling the automatic photographic function of conventional cameras and taking desired quality photos.

To achieve the foregoing objective, the present invention provides an image capturing device comprising a capturing module, a human detecting module, a face recognition module and a processing module. The capturing module sensing an image. The human detecting module is provided for detecting a number of at least one person in the image to generate a detecting signal. The face recognition module, recognizing a face condition of at least one person in the image to generate a recognition signal. The processing module is coupled to the capturing module, the human detecting module and the face recognition module and the processing module receiving the detecting signal and the recognition signal, calculating a number of at least one person according to the detecting signal, and calculating a face condition value according to the recognition signal, and the processing module further determines whether the number of at least one person and the face condition value match to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

Preferably, the face condition includes a proportion or size of the human face in the image, an angle of facing the capturing module, a facial expression characteristic, or a covered range.

Preferably, the predetermined face condition value is a proportion range value of the human face in the image, an angle of facing the capturing module range, a figure of a facial expression characteristic, and a covered range value of a covered face.

Preferably, the image capturing device of the present invention further comprises a setting module provided for setting the predetermined number and the predetermined face condition value.

Preferably, the image capturing device of the present invention further comprises a reminding module provided for receiving the image capturing signal to issue a reminding signal.

To achieve the foregoing objective, the present invention further provides an image capturing method, comprising the steps of: sensing an image by a capturing module; detecting a number of at least one person in the image by a human detecting module to generate a detecting signal; recognizing a face condition of the at least one person in the image by a face recognition module to generate a recognition signal; using a processing module to receive the detecting signal and the recognition signal, calculate a number of at least one person according to the detecting signal, and calculate a face condition value according to the recognition signal; and using the processing module to determine whether the number of at least one person and the face condition value match a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

To achieve the foregoing objective, the present invention further provides a human recognition photography system, applicable for an image capturing device, comprising: a human detecting module, provided to detect a number of at least one person in the image to generate a detecting signal, after a capturing module of the image capturing device senses an image; a face recognition module, recognizing a face condition of the at least one person in the image to generate a recognition signal; and a processing module, coupled to the human detecting module and the face recognition module, and the processing module receiving the detecting signal and the recognition signal, calculating a number of at least one person according to the detecting signal, and calculating a face condition value according to the recognition signal and the processing module further determining whether the number of at least one person and the face condition value match to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

In summation, the image capturing device, the image capturing method and the human recognition photography system in accordance with the present invention can use a human detecting module and a face recognition module to detect the number of at least one person and the human face characteristics when taking a photo by the automatic photographic function, so as to obtain the best photographic timing to capture an image and achieve a better photographic effect.

### BRIEF DESCRIPTION OF THE DRAWINGS

FIG. 1 is a block diagram of an image capturing device of the present invention;

FIG. 2 is a flow chart of an image capturing method of the present invention;

FIG. 3 is a block diagram of a human recognition photography system of the present invention;

FIG. 4A is a first schematic view of an image capturing device in accordance with a preferred embodiment of the present invention; and

FIG. 4B is a second schematic view of an image capturing device in accordance with a preferred embodiment of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

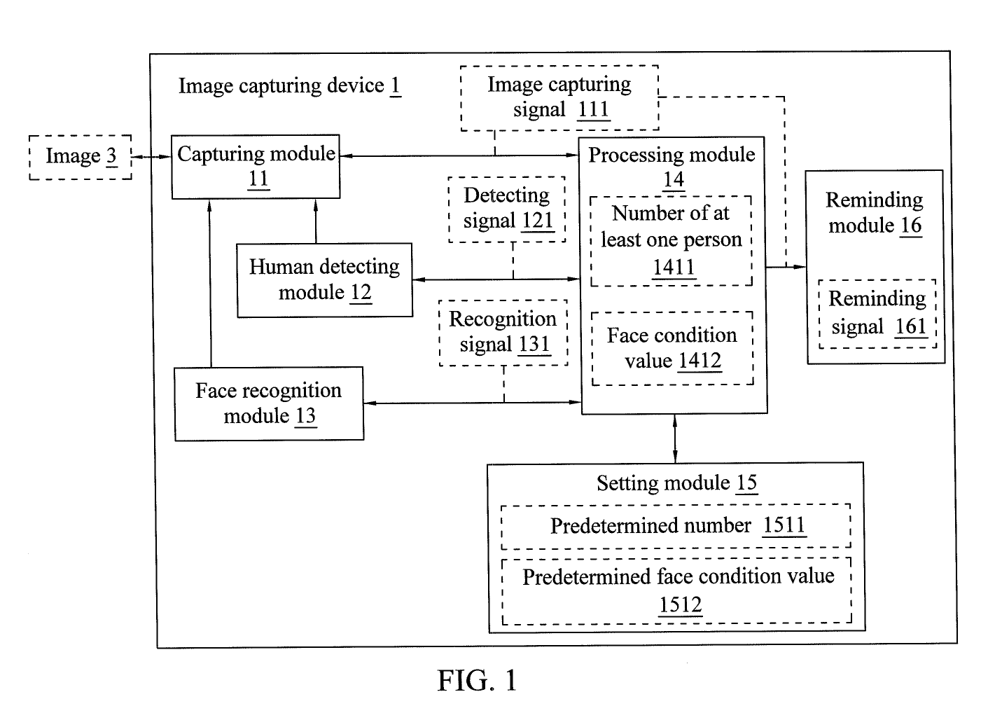

With reference to FIG. 1 for a block diagram of an image capturing device of a preferred embodiment of the present invention, the image capturing device 1 comprises a capturing module 11, a human detecting module 12, a face recognition module 13, a processing module 14, a setting module 15 and a reminding module 16. The processing module 14 is coupled to the capturing module 11, the human detecting module 12, the face recognition module 13, the setting module 15 and the reminding module 16, and the capturing module 11 is coupled to the human detecting module 12 and the face recognition module 13. The image capturing device 1 can be a digital camera, a Smartphone or any other device with a photographic function of any type or model. The capturing module 11 can be a camera lens, or an image sensing component. The processing module 14 can be a processor installed in the image capturing device 1 and used for computing different algorithms to process different image information. The reminding module 16 can be a light emitting diode (LED) lamp or a buzzer. However, the aforementioned devices and components are used for illustrating the present invention only, but not intended for limiting the present invention, and equivalents with the same effects can be used instead.

In the description above, when a user uses the image capturing device 1 to take a picture automatically, the capturing module 11 senses an image 3, and then the human detecting module 12 detects the number of at least one person in the image 3 to generate a detecting signal 121, and then the face recognition module 13 recognizes a face condition of the at least one person in the image 3 to generate a recognition signal 131. After the processing module 14 receives the detecting signal 121 and the recognition signal 131, the detecting signal 121 and the recognition signal 131 are computed to generate a number of at least one person 1411 and a face condition value 1412 respectively. The processing module 14 executes a determination procedure to determine whether the number of at least one person 1411 and the face condition value 1412 correspond to a predetermined number 1511 and a predetermined face condition value 1512 respectively; if yes, the processing module 14 will generate and transmit an image capturing signal 111 to the capturing module 11 and the reminding module 16. The reminding module 16 will generate a reminding signal 161 according to the image capturing signal 111 to inform the user that the image capturing device 1 is going to take a photo, and the capturing module 11 will capture an image 3 according to the image capturing signal 111 to generate image data. Wherein, if the number of at least one person 1411 and the face condition value 1412 correspond to the predetermined number 1511 and the predetermined face condition value 1512, the processing module 14 will generate the image capturing signal 111 to control the capturing module 11 to capture the image 3. In another embodiment, if either the number of at least one person 1411 or the face condition value 1412 corresponds to the predetermined number 1511 or the predetermined face condition value 1512, the processing module 14 will generate the image capturing signal 111.

In the description above, the user can preset the predetermined number 1511 and the predetermined face condition value 1512 by the setting module 15, wherein the aforementioned method of calculating the number of at least one person can include a calculation of the proportion or size of the at least one person in the image 3 or a determination whether or not to include the current position in the calculation of the quantity. The face condition can include a proportion or size of the human face in the image 3, an angle of facing the capturing module 11, a facial expression characteristic or a covered range. Therefore, the user can preset a predetermined face condition value 1512 such as a proportion range of the human face in the image 3, an angle range facing the capturing module 11 a facial expression characteristic figure, or a covered range of a covered face. For example, the user can set the predetermined face condition value 1512 such as setting the human face to a size of 1/12 of the image 3, the difference between the angles of the human face and the capturing module 11 within 30 degrees, the facial expression characteristic figure to a smile figure, or the covered portion of the covered human face to less than ¼ of the human face, and the face condition value 1412 produced by the processing module 14 must satisfy all of the aforementioned conditions before the capturing module 11 starts the photographic function. The aforementioned examples are used for illustrating the invention only, but the invention is not limited to these examples.

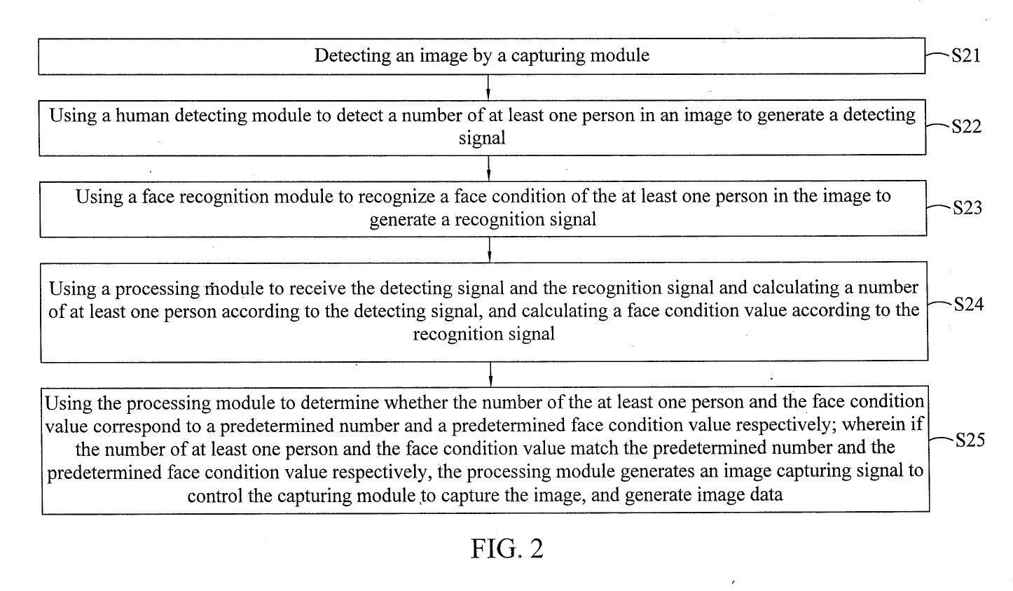

With reference to FIG. 2 for a flow chart of an image capturing method of the present invention, the image capturing method comprises the following steps:

S21: Detecting an image by a capturing module.

S22: Using a human detecting module to detect a number of at least one person in an image to generate a detecting signal

S23: Using a face recognition module to recognize a face condition of the at least one person in the image to generate a recognition signal.

S24: Using a processing module to receive the detecting signal and the recognition signal and calculating a number of at least one person according to the detecting signal, and calculating a face condition value according to the recognition signal.

S25: Using the processing module to determine whether the number of the at least one person and the face condition value correspond to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

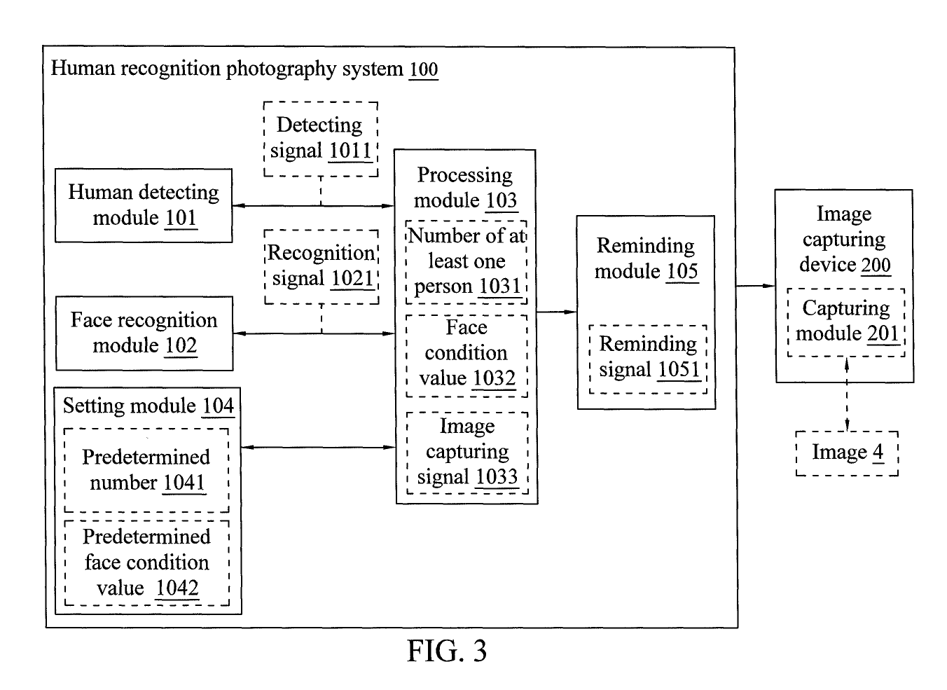

With reference to FIG. 3 for a block diagram of a human recognition photography system of the present invention, the human recognition photography system 100 is applicable to an image capturing device 200. The human recognition photography system 100 comprises a human detecting module 101, a face recognition module 102, a processing module 103, a setting module 104 and a reminding module 105. The human recognition photography system 100 can be an image processing software or system. The processing module 103 can be coupled to the human detecting module 101, the face recognition module 102, the setting module 104 and the reminding module 105. The image capturing device 200 can be a digital camera, a Smartphone, or a device with an image capturing function of any type or model and includes a capturing module 201. The capturing module 201 can be a camera lens or an image sensing component. The aforementioned examples are used for illustrating the invention only, but the invention is not limited to these examples.

In the description above, if a user uses the image capturing device 200 and turns on the automatic photographing function, the capturing module 201 will sense the image 4, and then the human detecting module 101 will detect the number of at least one person in the image 4 to generate a detecting signal 1011. The face recognition module 102 recognizes a face condition of the at least one person in the image 4 to generate a recognition signal 1021. After the processing module 103 receives the detecting signal 1011 and the recognition signal 1021, a number of at least one person 1031 can be calculated according to the detecting signal 1011, and a face condition value 1032 can be calculated according to the recognition signal 1021. The processing module 103 further performs a determination procedure according to a predetermined number 1041 and a predetermined face condition value 1042 preset into the setting module 104 by the user to determine whether the number of at least one person 1031 and the face condition value 1032 correspond to a predetermined number 1041 and a predetermined face condition value 1042; if yes, the processing module 103 will generate an image capturing signal 1033, and the reminding module 105 will generate a reminding signal 1051 according to the image capturing signal 1033 to inform the user capturing module 201 will take a photo, and finally the capturing module 201 can capture an image 4 according to the image capturing signal 1033 to generate image data. Compared with the conventional automatic photographic system that cannot detect a human or recognize a face before capturing the image, the present invention allows a user to enable the automatic photographing function first and then use the determination mechanism to detect the number of at least one person and recognize a face to determine the photographic timing, so as to take a picture automatically after obtaining the best photographic timing. Wherein, the user can set the predetermined number 1041 and the predetermined face condition value 1042 through the setting module 104. The predetermined number 1041 is the quantity of people. For example, if the number of people in the image 4 is equal to 4, the capturing module 201 will take the picture. The predetermined face condition value 1042 is a proportion range of a screen of a human face sensed by the capturing module 201, an angle range of the human face facing the capturing module 201, a facial expression characteristic figure or a covered range of a covered human face.

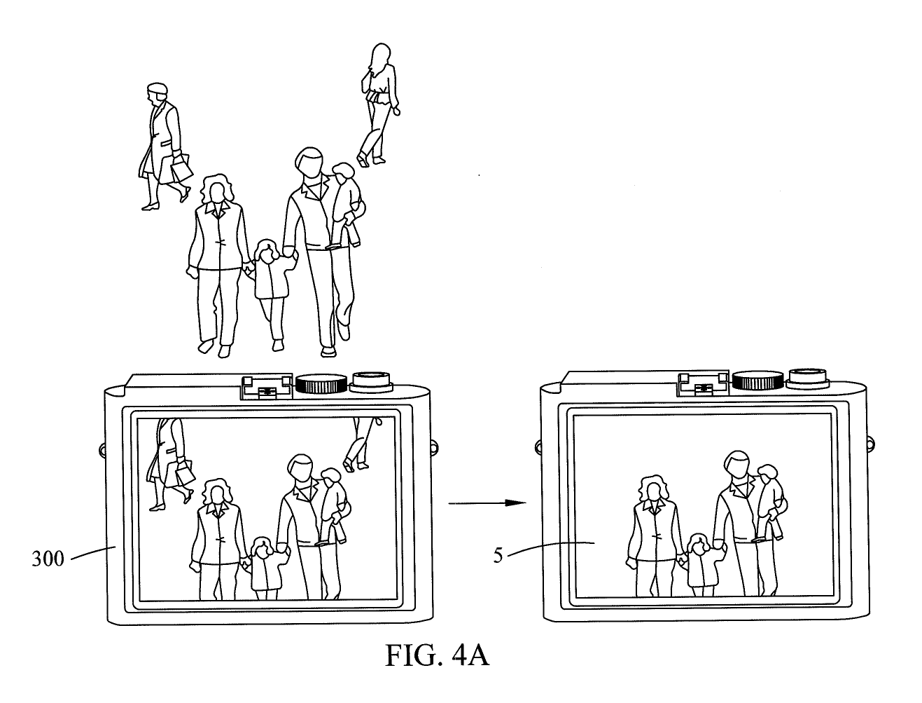

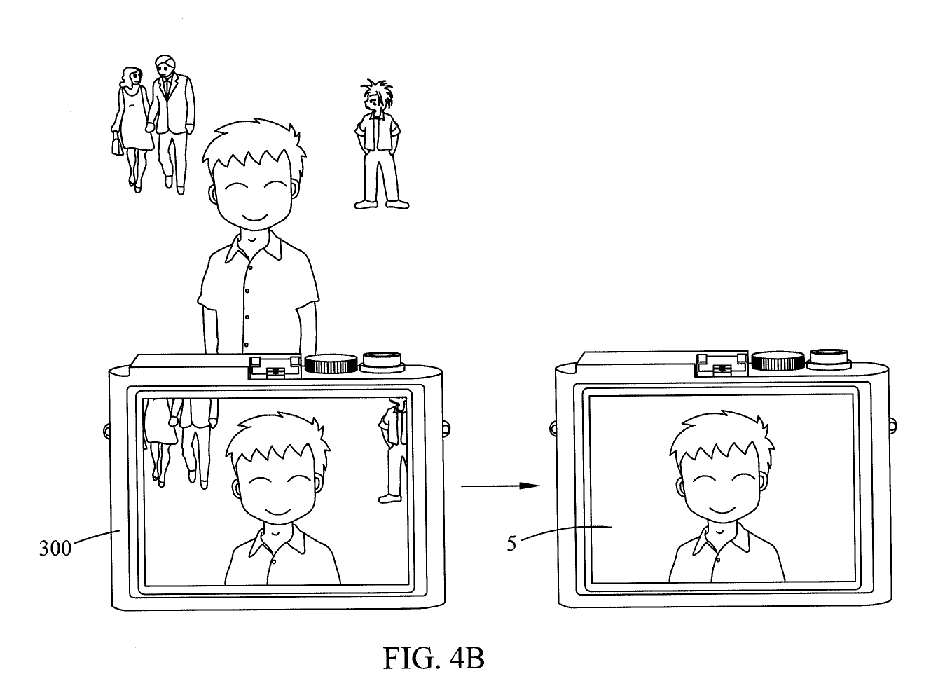

With reference to FIGS. 4A and 4B for the first and second schematic views of an image capturing device in accordance with a preferred embodiment of the present invention respectively, if a user wants to turn on the automatic photographic function to capture an image 5 outdoors and there is a crowd or a non-theme object appears in the shooting screen, the image capturing device 300 is provided for setting the photographic conditions in advance, and the photographic condition includes a predetermined number, etc. In this preferred embodiment, the predetermined number is set to 4, and then the automatic photographing function of the image capturing device 300 is turned on to sense an image 5, and the image capturing device 300 starts detecting the number of at least one person in the image 5 for the computation of quantity, and then the image capturing device 300 compares the detected number of at least one person and predetermined number. If the detected number of at least one person match the predetermined number set by the user, an image capturing signal is generated to capture the image 5 as shown in FIG. 4A. In FIG. 4A, the image capturing device 300 senses the image 5 and computes that the number of at least one person is equal to 6 which does not match with the predetermined number, so that the image capturing device 300 will not capture the image 5. After the number of at least one person in the image 5 is detected to be 4, and the number match with the predetermined number, so that the image capturing device 300 will capture the image 5 and generate image data.

In the description above, if the user executes the automatic photographing by using the timer method, the photographic procedure ends as soon as the countdown completes and the user can control the photographing timing more easily. However, if there are people walking around outdoors, the photo taken after the countdown completes may include non-theme objects, or the theme object is covered, so that the photo taken may have flaws to ruin the overall aesthetics. The users can use the image capturing device 300 to detect the number of at least one person to obtain a better automatic photographic timing, or the users can use the image capturing device 300 to set additional further photographic condition such as setting the predetermined face condition value of the at least one person, the proportion or size of a human face, and an angle or a position, etc. Therefore, after the image capturing device 300 senses an image 5, the number of at least one person is detected, and the human face condition is also detected. After the human face condition in the image 5 is recognized by the image capturing device 300, the image capturing device 300 calculates the face condition value of the at least one person according to the recognized result. If the human face in the image 5 occupies 1/12 of the image 5, the angle difference of the human face facing the camera lens of the image capturing device 300 falls within 30 degrees, or less than ¼ of the human face is covered, then the predetermined face condition value set before taking the photo is satisfied, so that an image capturing signal will be generated to capture the image 5 automatically as shown in FIG. 4B. Wherein, the users can set the facial expression characteristic of a face of the people into the predetermined face condition value, such as setting the predetermined face condition value to have a smile expression figure. However, this arrangement is provided as an example only, but the invention is not limited to this example.

In the description above, the image capturing device 300 further comprises an online threshold learning mechanism. If the image capturing device 300 performs recognitions according to the default value, and the result recognized by the image capturing device 300 may not match with the default value due to the photographic environment, this online threshold learning mechanism can be used to eliminate the too-narrow range of the photographic condition set by the user and overcome the problem of failing to capture the image 5 automatically, and the invention can make adjustments automatically after a predetermined time, and broaden the photographic conditions to facilitate users to capture the image automatically.

In summation of the description above, the image capturing device, the image capturing method and the human recognition photography system in accordance with of the present invention can detect the number of at least one person and the human face characteristic by the human detecting module and the face recognition module before using the image capturing device to capture images automatically, so as to obtain the best photographic timing to capture the images. Therefore, the present invention can overcome the drawbacks of photos taken by the conventional image capturing device with the automatic photographing function.

What is claimed is:

1. An image capturing device, comprising:
a capturing module, sensing an image;
a human detecting module, detecting a number of at least one person in the image to generate a detecting signal;
a face recognition module, recognizing a face condition of the at least one person in the image to generate a recognition signal; and
a processing module, coupled to the capturing module, the human detecting module and the face recognition module, and the processing module receiving the detecting signal and the recognition signal, calculating the number of at least one person according to the detecting signal, and calculating a face condition value according to the recognition signal, and the processing module further determining whether the number of at least one person and the face condition value match to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

2. The image capturing device of claim 1, wherein the face condition includes a proportion or size of the human face in the image, an angle of facing the capturing module, a facial expression characteristic, or a covered range.

3. The image capturing device of claim 1, wherein the predetermined face condition value is a proportion range value of the human face in the image, an angle of facing the capturing module range, a figure of a facial expression characteristic, and a covered range value of a covered face.

4. The image capturing device of claim 1, further comprising a setting module provided for setting the predetermined number and the predetermined face condition value.

5. The image capturing device of claim 1, further comprising a reminding module provided for receiving the image capturing signal to issue a reminding signal.

6. An image capturing method, comprising the steps of:
sensing an image by a capturing module;
detecting a number of at least one person in the image by a human detecting module to generate a detecting signal;
recognizing a face condition of the at least one person in the image by a face recognition module to generate a recognition signal;
using a processing module to receive the detecting signal and the recognition signal, calculate the number of at least one person according to the detecting signal, and calculate a face condition value according to the recognition signal; and
using the processing module to determine whether the number of at least one person and the face condition value match to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

7. The image capturing method of claim 6, wherein the face condition includes a proportion or size of the human face in the image, an angle of facing the capturing module, a facial expression characteristic, or a covered range.

8. The image capturing method of claim 6, wherein the predetermined face condition value is a proportion range value of the human face in the image, an angle of facing the capturing module range, a figure of a facial expression characteristic, and a covered range value of a covered face.

9. The image capturing method of claim 6, further comprising the step of setting the predetermined number and the predetermined face condition value by a setting module.

10. The image capturing method of claim 6, further comprising the step of receiving the image capturing signal by a reminding module to issue a reminding signal.

11. A human recognition photography system, applicable for an image capturing device, comprising:
a human detecting module, detecting a number of at least one person in the image to generate a detecting signal, after a capturing module of the image capturing device senses an image;
a face recognition module, recognizing a face condition of the at least one person in the image to generate a recognition signal; and
a processing module, coupled to the human detecting module and the face recognition module, and the processing module receiving the detecting signal and the recognition signal, calculating the number of at least one person according to the detecting signal, and calculating a face condition value according to the recognition signal and the processing module further determining whether the number of at least one person and the face condition value match to a predetermined number and a predetermined face condition value respectively; wherein if the number of at least one person and the face condition value match the predetermined number and the predetermined face condition value respectively, the processing module generates an image capturing signal to control the capturing module to capture the image, and generate image data.

12. The human recognition photography system of claim 11, wherein the face condition includes a proportion or size of the human face in the image, an angle of facing the capturing module, a facial expression characteristic, or a covered range.

13. The human recognition photography system of claim 11, wherein the predetermined face condition value is a proportion range value of the human face in the image, an angle of facing the capturing module range, a figure of a facial expression characteristic, and a covered range value of a covered face.

14. The human recognition photography system of claim 11, further comprising a setting module provided for setting the predetermined number and the predetermined face condition value.

15. The human recognition photography system of claim 11, further comprising a reminding module provided for receiving the image capturing signal to issue a reminding signal.
